(19) United States
(12) Patent Application Publication
(10) Pub. No.: US 2010/0290477 A1
(43) Pub. Date: Nov. 18, 2010

(54) METHOD FOR ROUTING TRAFFIC IN A GATEWAY

(75) Inventor: Geert Goemaere, Schoten (BE)

Correspondence Address: Robert D. Shedd, Patent Operations;THOMSON Licensing LLC, P.O. Box 5312, Princeton, NJ, 08543-5312, US

(73) Assignee: THOMSON LICENSING

(21) Appl. No.: 12/735,458

(22) PCT Filed: Jan. 30, 2009
(86) PCT No.: PCT/EP2009/051061

§ 371 Date: Jul. 19, 2010

(30) Foreign Application Priority Data
Feb. 1, 2008 (EP) 08447003.8

(51) Int. Cl. H04L 12/56

(52) U.S. Cl. 370/401

(57) ABSTRACT

The present invention concerns a gateway device comprising a first interface to a first network, a second interface to a second network, the getaway having an address on the second network, a router that is adapted to route traffic between the first network, the second network and the gateway, a tunneling module that is adapted to lease the address to a first device located on the first network, a host module for sending and receiving traffic through said router, and a tracking module that is adapted to enable the host module to communicate to the second network when the address is leased to the first device.

### FIELD OF THE INVENTION

The present invention relates generally to a gateway and in particular to a method for routing traffic in a gateway.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A gateway enables to connect a local area network to the Internet. Due to the limited number of Internet Protocol (IP) Version 4 addresses, Internet service providers typically only give one global IP address to each gateway. A device located on the local area network attached to a gateway is given a private IP address. The private IP address permits the local device to communicate to other local devices of the LAN. It also permits the local device to communicate with other subscribers or with servers on the Internet. The Internet Gateway device translates the private IP address into the public IP address. This translation is commonly referred to as Network Address Translation (NAT).

A feature in the gateway, called IP pass-through, provides tunneling between a device located on the LAN and the Internet. The IP pass-through is a feature implemented in some routers, such as for example the Netopia Series Routers. It is described, in particular, in the Netopia Software User Guide version 7.5 chapter 3. The local device appears to be IP transparent to the gateway. The service applications running on the local device with the public IP address are transparent for NAT because the IP address is a public address which is routable from the Internet. However some service applications running on the gateway can no longer communicate to the Internet. The gateway can not use its private IP address with NAT, because the public IP address has been leased to the local device.

### SUMMARY OF THE INVENTION

The present invention attempts to remedy at least some of the concerns connected with IP pass-through feature in the prior art, by providing a routing mechanism that enable the gateway to communicate to the Internet in the presence of the IP pass-through feature.

The present invention concerns a gateway device comprising a first interface to a first network, a second interface to a second network, the getaway having an address on the second network, a router that is adapted to route traffic between the first network, the second network and the gateway, a tunneling module that is adapted to lease the address to a first device located on the first network, a host module for sending and receiving traffic through the router, and a tracking module that is adapted to enable the host module to communicate to the second network when the address is leased to the first device.

The gateway according to the invention enables an application of the gateway to communicate to a device located on the Internet, even when the glocal IP address is leased to a device of the local network. The tracking module has no impact on the NAT. The routing mechanism of the host is NAT transparent.

According to an embodiment, the tracking module being adapted to track traffic from the host module and to route traffic destined to the host module.

According to an embodiment, the tracking module is adapted to make the router forwarding traffic destined to the host module.

The invention also concerns a method at a gateway device for routing traffic, the gateway having received an IP public address from a device on the Internet, and the IP address being leased to a device located on the local area network. The method comprises the steps of sending a packet from a host module located in the gateway to a device located on the Internet, and sending the response received from the device to the host module.

Another object of the invention is a computer program product comprising program code instructions for executing the steps of the process according to the invention, when that program is executed on a computer. By “computer program product”, it is meant a computer program support, which may consist not only in a storing space containing the program, such as a diskette or a cassette, but also in a signal, such as an electrical or optical signal.

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

### BRIEF DESCRIPTION OF THE DRAWINGS

The invention will be better understood and illustrated by means of the following embodiment and execution examples, in no way limitative, with reference to the appended figures on which:

FIG. 1 is a block diagram a system compliant with the embodiment.

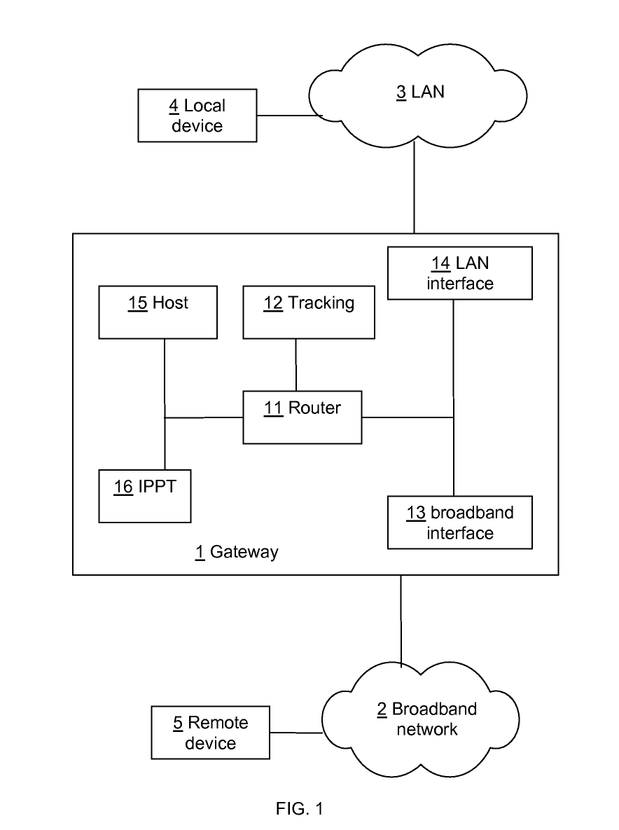

In FIG. 1, the represented blocks are purely functional entities, which do not necessarily correspond to physically separate entities. Namely, they could be developed in the form of hardware or software, or be implemented in one or several integrated circuits.

### DETAILED DESCRIPTION OF PREFERRED EMBODIMENTS

The exemplary embodiment comes within the framework of routing in a gateway, but the invention is not limited to this particular environment and may be applied within other frameworks where routing is performed.

The system according to the embodiment is illustrated in the FIG. 1. A gateway 1 comprises a LAN interface 14 to a first network that is a local area network 3. It comprises a broadband interface 13 to a second network that is a broadband network 2. The local area network is an Ethernet type network, and might be any type of local area network technology well known to the skilled person in the art. In particular the broadband interface is a digital subscriber line, DSL. A remote device 5 is connected to the second network.

The gateway comprises a router 11 and a tracking module 12 that is adapted to configure the router according to the embodiment.

The gateway comprises an IP pass-through module (IPPT) 16 that provides the IP pass-through feature to the local device 4 on the LAN 3. It is also called a tunneling module. It builds a tunnel to the local device 4 on the LAN that is IP transparent to the gateway. All traffic originating from the WAN is forwarded to the local device. And all traffic from the local device is forwarded to the Internet. In another words, the gateway leases the public IP address to the local device 4 on the LAN 3. A route is configured in the router. The local device is a desktop. It might be any type of device that can connect to a local network and communicate with devices on the Internet.

The gateway comprises a host module 15 that enables the gateway to send and receive traffic through the router. The host module is attached to the loopback interface of the router. The loopback interface is configured in a statefull mode. In that mode, for traffic originating from the gateway, i.e. originating on loopback interface, the router sends response traffic back to the loopback interface of the router. That traffic also uses the public IP address.

Traffic flow in the gateway is now described.

An Initial packet originating from the host is destined to the remote device. The initial packet enters the router at the loopback interface.

A route is found in the router to the remote device with destination link set to the Internet interface.

The tracking module keeps a track of the current connection and the route entry in a cache. The source link is cached for the initiating stream of the connection.

The relevant information cached per stream comprises the following: the source interface number, the source IP address, the protocol used, the source port, the destination IP address and the destination port. It also comprises the routing information (route destination interface).

The Initial packet is forwarded to the Internet interface of the router.

At reception of a response packet from the remote device:

The response packet from remote device enters the router on the Internet link.

The tracking module tracks connections and fetches the cache for this connection.

The cache indicates that the source link of the initiating stream is configured in statefull mode. This means that the responder packet shall be sent to the source link of the initiating packet, which is the loopback interface.

The tracking module makes the router forward the responder packet to the loopback interface. No route entry is needed at the router to forward the packet.

An example of a stream transfer between the local device 4 and the remote device 5 through the gateway 1 is illustrated hereinbelow. The following traffic parameters are used:
Local device IP address=80.0.0.1, port=1024, protocol=tcp
Remote device IP address=60.0.0.1, port=1024, protocol=tcp

The gateway numbers its network interfaces so it can track from where traffic comes. Network interface numbers are only significant on the gateway and are not known at the local or remote device. Packets flowing from the local to the remote device are called stream 1 (S1) and returning packets are called stream 2 (S2). Both streams are related to each other and form a connection.

Information cached by the tracking module on the gateway is illustrated in the following table:

| | source | | source | source | destination | destination |
|---|---|---|---|---|---|---|
| stream | interface | protocol | address | port | address | port |
| S1 | 1 | tcp | 80.0.0.1 | 1024 | 60.0.0.1 | 80 |
| S2 | 2 | tcp | 60.0.0.1 | 80 | 80.0.0.1 | 1024 |

The packets returning from the web server actually carry {protocol, source address, source port, destination address, destination port} in the TCP/IP packet. This information together with the interface number on which the packet is received, is used to lookup the cache entry in the tracking module. The tracking module finds an entry for S2 and knows that it is related to S1 (the other stream of the same connection).

In the statefull routing case, the S1 cache entry contains the number of the interface to where returning packets have to be sent to.

The applications running on the local device and the applications running on the gateway are NAT transparent. The tracking module is represented in a module separate from the router. Of course the tracking module could be embedded in the router.

References disclosed in the description, the claims and the drawings may be provided independently or in any appropriate combination. Features may, where appropriate, be implemented in hardware, software, or a combination of the two.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments necessarily mutually exclusive of other embodiments.

Reference numerals appearing in the claims are by way of illustration only and shall have no limiting effect on the scope of the claims.

1. A gateway device comprising:
a first interface to a first network,
a second interface to a second network, said getaway having an address on said second network,
a router adapted to route traffic between the first network, the second network and the gateway,
a tunneling module adapted to lease the address to a first device located on said first network, and
a host module for sending and receiving traffic through said router,
wherein it comprises a tracking module that is adapted to enable said host module to communicate to the second network when the address is leased to the first device.

2. Gateway according to claim 1, said tracking module being adapted to track traffic from said host module and to route traffic destined to said host module.

3. Gateway according to claim 2, said tracking module being adapted to make the router forwarding traffic destined to said host module.

4. Method at a gateway device for routing traffic, said gateway having received an IP public address from a device on the Internet, and said IP address being leased to a device located on the local area network, wherein it comprises the steps of:
sending a packet from a host module located in said gateway to a device located on the Internet, and
sending the response received from said device to said host module.
